(19) United States
(12) Patent Application Publication
(10) Pub. No.: US 2025/0052363 A1
(43) Pub. Date: Feb. 13, 2025

(54) SELF-CLIMBING CABLE

(71) Applicant: Steven McCharles, Clarence Creek (CA)

(72) Inventor: Steven McCharles, Clarence Creek (CA)

(21) Appl. No.: 18/447,537

(22) Filed: Aug. 10, 2023

(51) Int. Cl. F16M 13/02

(52) U.S. Cl. CPC F16M 13/02; A01M 31/02

(57) ABSTRACT

A treestand self-climbing unitary cable for securing a treestand to a post or tree (support column). The unitary cable of this invention allows more and safer contact with the support column and is convenient to use.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The applicant is aware of the following prior art, U.S. Pat. No. 5,316,104 that issued May 31, 1994, to Amacker deals with a mechanical device for securing a treestand to a vertical pole or tree. The assembly does not use a strap or cord to secure the treestand.

U.S. Pat. No. 5,492,196 that issued on Feb. 20, 1996, deals with a portable deer and treestand that is secured to an upright pole or tree that uses a strap with a hook. The strap surrounds a tree with the hook coupled with a securement hoop of the treestand.

U.S. Pat. No. 5,996,738 that issued Dec. 7, 1999, to Nelsen deals with a portable tree climbing device with a platform capable of supporting a user above ground level. It uses a tree encircling member that secures its position by the use of locking pins. This is mechanical and is not a strap.

### BRIEF SUMMARY OF THE INVENTION

Thus, what is disclosed and claimed herein is a self-climbing treestand cable comprising two predetermined lengths of cable, each having two ends, said cables having a predetermined width, a predetermined thickness and a center portion along said length, said cables being intertwined to form a unitary cable.

The unitary cable has spaced-apart enlarged nodules along its length. There are at least three nodules near the center portion of the unitary cable having spiked bolts extending from an interior surface of the nodules.

The cable has spaced-apart enlarged nodules along its length and there is at least five of the nodules near the center portion of the cable having spiked bolts extending from an interior surface of the nodules.

### BRIEF DESCRIPTION OF THE SEVERAL VIEWS OF THE DRAWING(S)

FIG. 1 is a top view of a cable of this invention.

FIG. 2 is a front view of a portion of FIG. 1.

FIG. 3 is an enlarged nodule showing a spike.

FIG. 4 is a top view of an end of the cable of FIG. 1.

FIG. 5 is an illustration of the locking mechanism for the cable in a treestand showing an open position.

FIG. 6 is a full front view of the housing for the locking mechanism of FIG. 5.

FIG. 7 is an illustration of the locking mechanism for the cable as shown in FIG. 6 showing a closed position.

FIG. 8 is a full front view of a spike of this invention.

### DETAILED DESCRIPTION OF THE INVENTION AND DRAWINGS

The present invention deals with a treestand self-climbing unitary cable for securing a treestand to a post or tree (support column, not shown). The unitary cable of this invention allows more and safer contact with the support column. The cable 1 consists of two predetermined lengths of cable each having two ends. The cables are intertwined to form a unitary cable. The unitary cable can be manufactured from solid wire, metal cable, hard rubber, fiberglass, or composites and the like. The useful length of the cable is generally from 24 inches to 72 inches.

Preferred for this invention is stainless steel wire rope that is 1×19 3/16 inches. This cable is available from Pacific rigging, San Diego California 92113.

The width of the cable is dependent on the end use, and such width can be, for example, ½ to 1 inch wide. The thickness of the unitary cable is in the range of 3/16 to ½ inches. These dimensions prevent the unitary cable from rolling over when in contact with the support column.

The unitary cable 1 has spaced-apart nodules 2 that are fixedly attached to the unitary cable 1. The nodules 2 have a size selected from nodules ½ to ¾ inches in length, ½ to ¾ inches in width, and 3/16 to ½ inch in thickness.

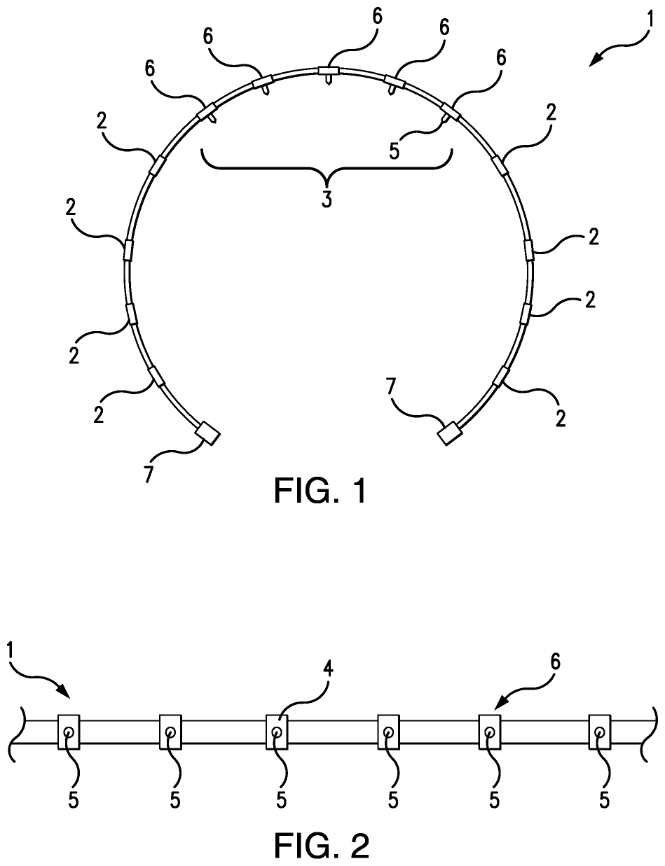

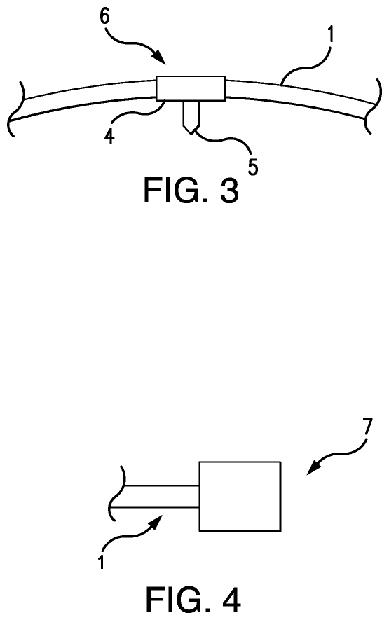

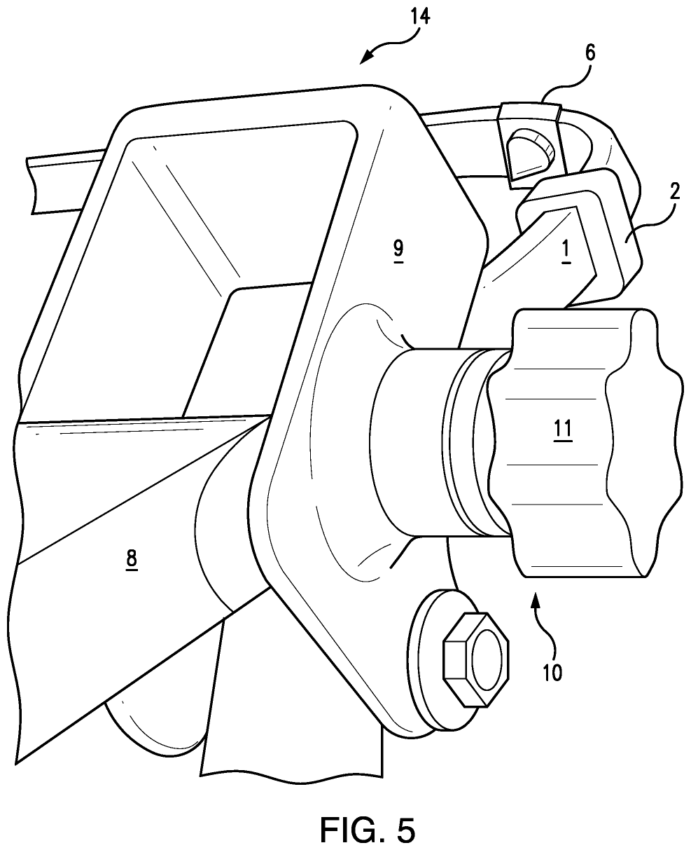

At least 3 spiked nodules 6 are present on the unitary cable 1 near a center portion 3 of the unitary cable 1 and spiked bolts 5 extend from an interior surface 4 of the nodules 6 (See FIGS. 1 and 3). The spiked bolts 5 are threaded 15, and they are threaded into the nodule 6. Thus, one can easily put a spiked bolt 5 together by simply screwing a spiked bolt into the face of the nodule 6. By the same token, the spiked bolt can be removed if required using a wrench.

For purposes of this invention, the spiked bolts are generally ½ inch to 1 inch in overall length while the spike portion of the spiked bolt is ¼ to ½ inch in length from the interior surface of the nodule.

The spiked bolts 6 bite into the support column eliminating or reducing the risk of the unitary cable 1 from slipping down the support column and allowing the treestand to come down out of the support column. This incident is the main concern and cause of self-climbing treestand incidents. The spiked bolts of this invention allow for secure biting action into the support column but have a relatively easy release from the support column without any extra effort.

FIG. 1 shows a full top view of a unitary cable of this invention. Shown is the unitary cable 1, the nodules 2, the spiked nodules 6 and the end nodules 7. FIG. 2 shows a portion of the front face of the unitary cable 1.

The end nodules 7 are usually slightly larger than the nodules for 2 and 6 as this is the means by which the unitary cable 1 is held to the treestand. Shown in FIG. 5 is an illustration of the tail end 14 of a treestand support that is adopted to hold the end of the unitary cable 1. The portion of the tail end 14 of a treestand is not part of the instant invention. The nodules are generally manufactured from metal, plastics, or hard rubber.

The unitary cable is covered in shrink wrap rubber or plastic.

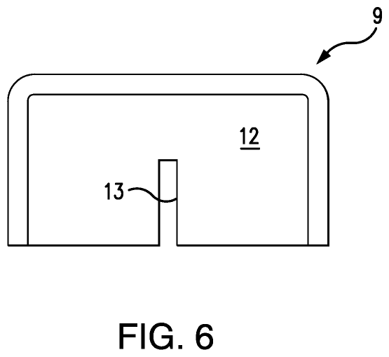

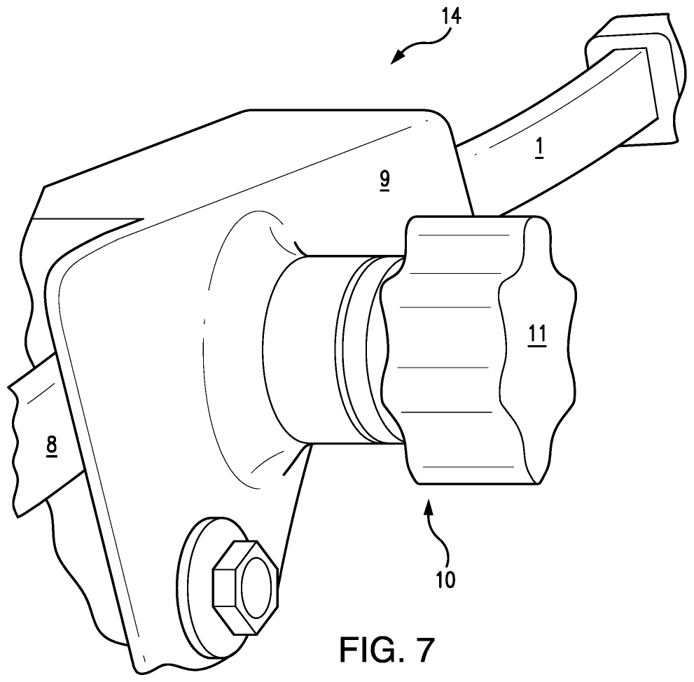

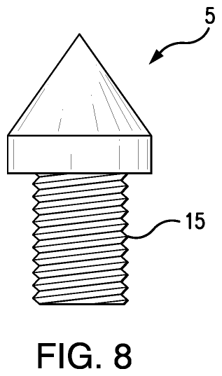

Shown in FIG. 5 is a horizontal treestand brace 8, which is shown for illustration purposes and is not part of the instant invention, having a housing 9 mounted on it. The housing 9 is partially rotatable around the outside of the treestand brace 8 and the position shown is open. There is shown a unitary cable 1, inserted into the housing 9. The control 10 on the right-hand side of the illustration is used to control the movement of the housing 9 and as such, one pulls and turns the knob 11 to allow movement of the housing. In the open position, the housing 9 allows for the insertion of one end of a cable 1 into the interior of the housing 9. As shown in FIG. 6, the front face 12 of the housing has a slot 13. This slot 13 is large enough for the unitary cable 1 to fit, but the end nodule 7 will not pass through the slot 13. FIG. 7 shows the housing 9 closed and by this means, the unitary cable 1 cannot escape the housing 9. Text here.

What is claimed is:

1. A self-climbing treestand cable comprising:
a. two predetermined lengths of cable each cable having two ends, said cables having a predetermined width, a predetermined thickness and a center portion along said length, said cables being intertwined to form a unitary cable;
b. said unitary cable having spaced-apart enlarged nodules along said length;
c. at least three said nodules near said center portion of said unitary cable having spiked bolts extending from an interior surface of said nodules.

2. A self-climbing treestand unitary cable as claimed in claim 1 wherein said unitary cable is covered in shrink wrap rubber.

3. A self-climbing treestand unitary cable as claimed in claim 1 wherein said unitary cable is covered in shrink wrap plastic.

4. A self-climbing treestand unitary cable as claimed in claim 1 wherein said unitary cable is manufactured from a material selected from the group consisting of:
a. wire rope,
b. zinc coated wire rope,
c. solid wire,
d. hard rubber and
e. composite material.

5. A self-climbing treestand cable as claimed in claim 1 wherein said unitary cable is manufactured from cables having 24 to 72 inches in length, ½ to 1 inch in width, and 3/16 to ½ inch in thickness.

6. A self-climbing treestand cable as claimed in claim 1 wherein said spiked bolts are ½ inch to 1 inch in overall length.

7. A self-climbing treestand cable as claimed in claim 1 wherein said spike of said spiked bolts is ¼ inch to ½ inch in length.

8. A self-climbing treestand cable as claimed in claim 1 wherein a terminal end opposite of said spike of said spiked bolts is threaded.

9. A self-climbing treestand cable as claimed in claim 1 wherein said nodules are manufactured from the group consisting of
(i) metal,
ii) plastic, and
iii) hard rubber.

10. A self-climbing treestand cable as claimed in claim 9 wherein said metal is iron.

11. A self-climbing treestand cable as claimed in claim 9 wherein said metal is aluminum.

12. A self-climbing treestand cable as claimed in claim 1 wherein said cable nodules are ½ inch to ¾ inch in length, ½ inch to ¾ inch in width, and 3/16 inch to ½ inch in thickness.
